(19) United States
(12) Patent Application Publication
(10) Pub. No.: US 2007/0016517 A1
(43) Pub. Date: Jan. 18, 2007

(54) Method and apparatus for enabling mortgage officer to increase credit score to secure loan for consumer

(76) Inventor: Barbara J. Solomon, Chandler, AZ (US)

Correspondence Address: TOD R NISSLE, PO BOX 55630, PHOENIX, AZ, 85078, US

(21) Appl. No.: 11/184,585

(22) Filed: Jul. 18, 2005

(51) Int. Cl. G06Q 40/00

(52) U.S. Cl. 705/38

(57) ABSTRACT

An apparatus and method permits a mortgage officer to accurately determine by how much a corrective action will increase the credit report score of a loan applicant. Common corrective actions are provided along with conservative highly accurate projections of how much a particular action will increase the credit report score of a consumer.

This invention relates to real estate loans.

More particularly, the invention relates to a method and apparatus for enabling a mortgage officer to facilitate obtaining a real estate loan for a consumer.

In a further respect, the invention relates to a method and apparatus for enabling a mortgage officer independently of a consumer to evaluate the consumer's credit report and determine and carry out the steps necessary to increase the consumer's credit score to facilitate obtaining a loan.

There appear to be wide spread misconceptions and misunderstandings concerning credit reports and credit scoring. For example, many consumers are aware that a credit report can be purchased over the Internet from a variety of companies. Consumers often are not, however, aware that the credit report that they purchase may be of little value to them either in obtaining a loan or in accurately accessing their credit rating.

Equifax, Trans Union, and Experian function as warehouses of data concerning a consumer's financial transactions. Each of these “Big Three” credit bureaus has its own in-house method of calculating a credit score for a consumer. There also exist however, approximately 180 “Trimerge” companies.

Each of the Trimerge companies purchases consumer financial transaction data from one or more of the “Big Three” credit bureaus. Each of the Trimerge companies has its own system for calculating a credit score for a consumer. The method used by one Trimerge company can vary from the method used by another Trimerge company. For example, the date of last activity in a consumer's credit card account or other account is important in determining the consumer's credit score. Some Trimerge company credit report formats do not include information indicating the dates of last activity in the credit card accounts of a consumer. Further, most banks do not utilize credit reports from the Big Three, do not utilize credit reports from most Trimerge companies, and do not use credit reports that are provided over the Internet by other companies. Credit reports from any of these sources are therefore of little use to banks. Instead, most banks only utilize credit reports provided by one particular Trimerge company, namely Credco. Automobile dealers do utilize credit reports produced by the Big Three, but only in part because the credit reports prepared by the Big Three include an “auto portion” that reflects the reliability of the consumer in making payments on automobile loans. A credit report that a consumer obtains from the Internet, that gives a consumer a relatively high credit score, and that does not indicate the consumer's history in paying off automobile loans may be of limited use to an automobile dealer.

Sixty to eighty percent of consumers in the United States have a credit rating or score that is below 620. If a consumer's credit score is below 620, the consumer ordinarily can not secure a loan to buy or refinance a home. Mortgage officers often find themselves in a situation in which a loan could be secured for a consumer if the consumer's credit score could be increased. Mortgage officers ordinarily do not, however, know with any degree of accuracy how much a consumer's credit score will be increased if a particular corrective action is taken with respect to the consumer's credit card accounts, medical accounts, car loans, home mortgage, and other financial accounts that appear on the consumer's credit report. For example, if a mortgage officer reviews the credit card balances of a consumer, the mortgage officer may not know what action to take to improve the credit score of the consumer and, even if the mortgage officer believes that a particular action should improve the credit score of a consumer, the mortgage officer does not know by how much the credit score will improve. Or, if the mortgage officer knows that a medical bill is outstanding, he may believe that paying the medical bill will improve the consumer's credit score, but he is not certain and he is not certain by how much the consumer's credit score will increase.

A mortgage officer can obtain from a Trimerge company a rescore of a consumer's credit report by submitting a written letter from a creditor listed on the credit report. The written letter indicates that a portion of the credit report is incorrect. When that portion of the credit report is corrected, the consumer's credit score may increase. When the mortgage officer submits the letter, the Trimerge company does not, however, indicate to the mortgage office the amount by which the consumer's score will increase. Instead, the Trimerge company contacts one or all of the Big Three credit bureaus and transmits to the credit bureau a copy of the creditor's letter, usually with a copy of the consumer's credit report. The credit bureau confirms the accuracy of the written letter by, for example, determining that a payment was made on a consumer's account, by confirming with the creditor that an account was mistakenly listed on the consumer's credit report, etc. The credit bureau then reports back to the Trimerge company and confirms the accuracy of the creditor's letter, after which the Trimerge company uses its own software and methodology to rescore the consumer's credit report and then informs the mortgage officer of the rescore. The foregoing process can take several days. If the action taken by the mortgage officer does not, even if confirmed as accurate by the Big Three bureau, increase the consumer's credit score at all or increase the consumer's credit score sufficiently, then the mortgage officer has wasted several days without advancing the consumer's cause in securing a loan.

Accordingly, it would be highly desirable to provide an improved real estate loan process in which a mortgage officer can with a high degree of certainty determine prior to taking an action on behalf of a consumer how much that action will increase the credit score of the consumer.

Therefore, it is a principal object of the invention to provide an improved real estate loan application process.

Another object of the invention is to provide an improved real estate loan application process in which a loan officer can independently of a consumer, of a Trimerge company, and of the Big Three credit bureaus accurately determine with a high degree of certainty the amount a particular action with respect to a consumer's financial account will increase the consumer's credit score.

These and other, further and more specific objects and advantages of the invention will be apparent to those of skill in the art from the following detailed description thereof, taken in conjunction with the drawings, in which:

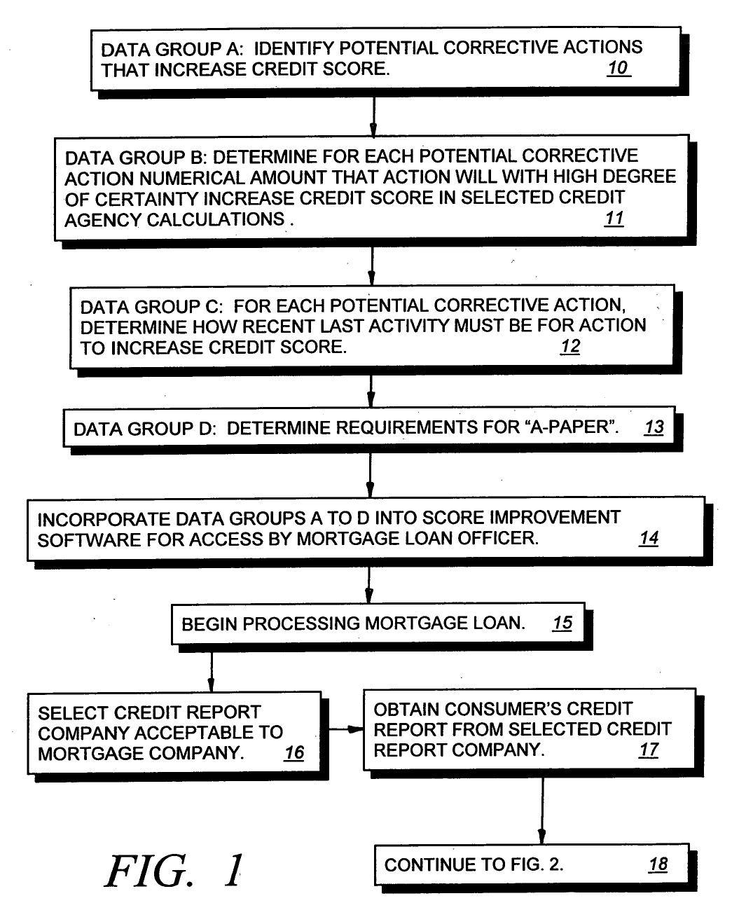

FIG. 1 is block flow diagram illustrating a mortgage loan processing method in accordance with the invention;

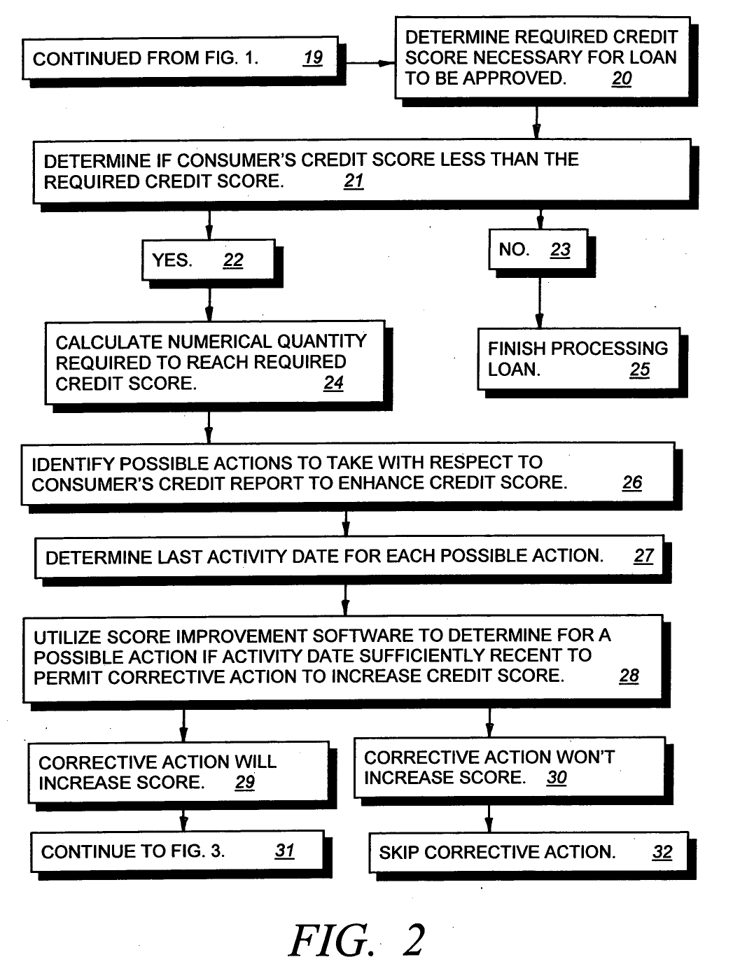

FIG. 2 is a block flow diagram further illustrating the mortgage loan processing method of FIG. 1;

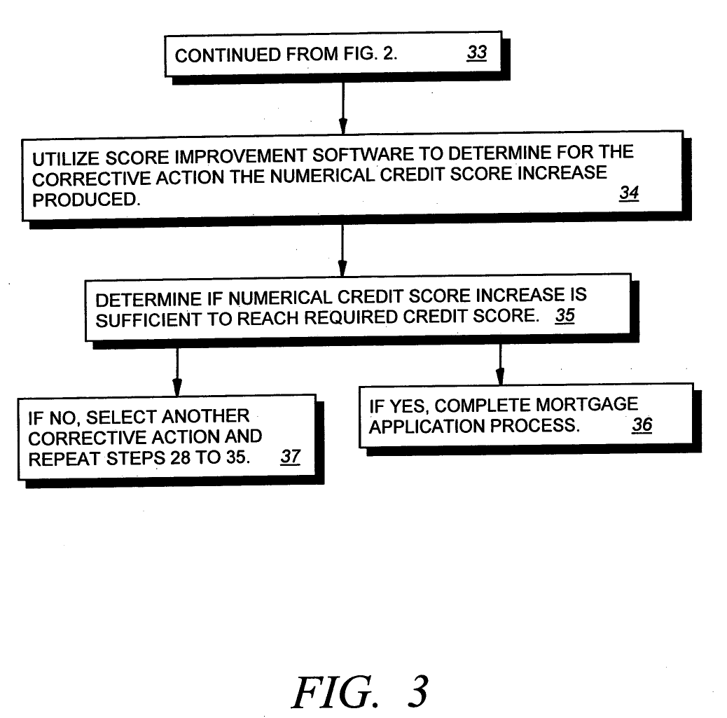

FIG. 3 is a block flow diagram further illustrating the mortgage loan processing method of FIG. 1; and,

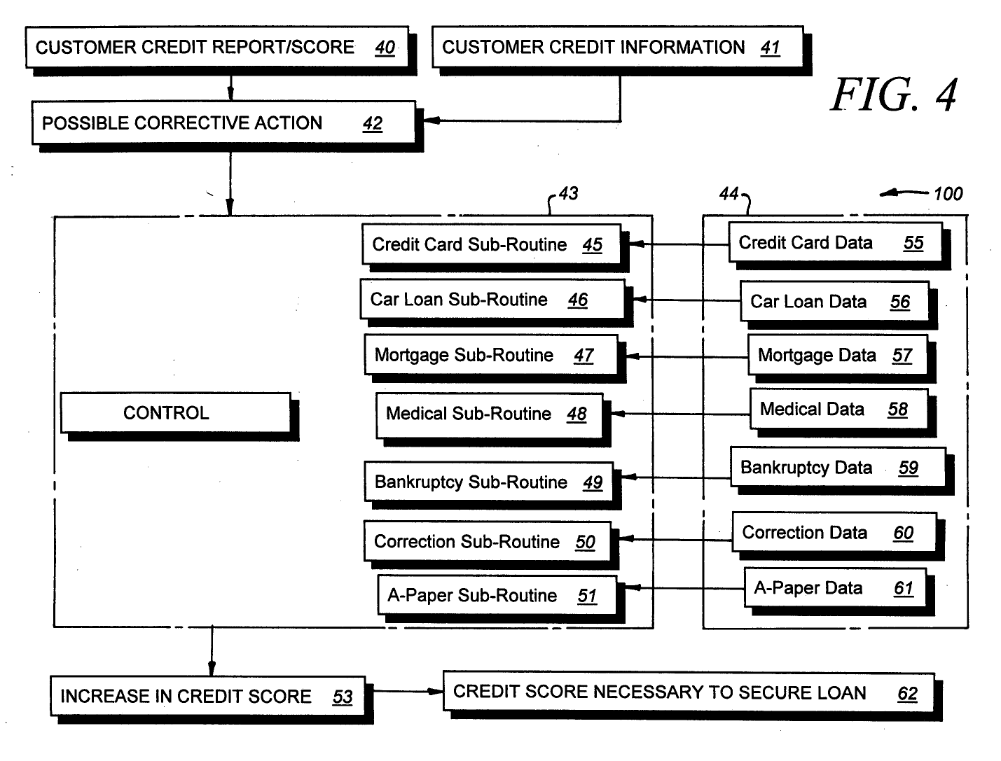

FIG. 4 is a block diagram illustrating the apparatus utilized in the system of the invention.

Briefly, in accordance with the invention, I provide an improved method for use in processing a mortgage loan for a customer having financial records and having a credit report score less that the score necessary to obtain the mortgage loan. The method includes the steps of providing a computer program that provides for each of a plurality of different corrective financial actions with a high degree of certainty a specific conservative amount by which the corrective financial action increases a customer's credit report score as calculated by a selected credit bureau; determining a required credit score necessary to secure the loan from a selected mortgage company; determining the customer's actual credit score; determining the amount by which the customer's actual credit score must be increased to reach the required credit score of the selected mortgage company; reviewing a credit report on the customer to select at least one possible selected corrective action to increase the customer's credit score; utilizing the computer program to determine for the selected corrective action the specific conservative amount by which the selected corrective financial action increases the customer's credit report score; determining if the specific conservative amount for the selected corrective action is at least equal to the amount by which the customer's actual credit score must be increased; and, if the specific conservative amount for the selected corrective action is at least equal to the amount by which the customer's actual credit score must be increased, continuing processing the loan.

In another embodiment of the invention, I provide improved apparatus for facilitating by a mortgage officer the processing of a mortgage loan for a customer having financial records and having a credit report score less than the score necessary to obtain the mortgage loan. The apparatus comprises a computer for the mortgage officer; a computer program on the computer that provides for each of a plurality of different corrective financial actions with a high degree of certainty a specific conservative amount by which the corrective financial action increases a customer's credit report score as calculated by a selected credit bureau, and a plurality of correction formats for the mortgage officer to correspond with a credit bureau to alter customer data maintained by the credit bureau; a credit report on the customer to enable selection by the mortgage officer of at least one possible selected corrective action to increase the customer's credit score; and, a printer for the mortgage officer to print said correction formats.

Turning now to the drawings, which depict the presently preferred embodiments of the invention for the purpose of illustration thereof, and not by way of limitation of the invention, and in which like characters refer to corresponding elements throughout the several views, FIGS. 1 to 3 illustrate a method of processing a mortgage loan for a customer having financial records and having a credit report score less that the score necessary to obtain the mortgage loan. In step 10, data is obtained that identifies potential corrective actions that can be taken to increase the credit score of a consumer or business entity. In step 11, data is obtained that determines and assigns to each potential corrective action a credit score increase. The assigned credit score increase is conservative and with a high degree of certainty indicates the minimum amount by which a consumer's score will increase if the related corrective action is taken. As used herein, a high degree of certainty indicates that a consumer's credit score produced by a particular credit bureau or Trimerge company has, based on historical information earlier collected concerning how much the credit bureau or Trimerge company increases a credit score for a particular corrective action, at least a 80% likelihood of being increased by the amount indicated for that particular corrective action. It is presently preferred however, that there is at least a 95% likelihood or degree of certainty, and most preferably preferred that there is at least a 99% likelihood or degree of certainty, that the consumer's score will be increased by the amount indicated.

One procedure for determining the amount by which a consumer's score will increase for a particular corrective action is to monitor for a selected period of time (which period of time is usually at least one month, preferably is at least six months, and most preferably is at least one year) at least one of the Big Three credit bureaus (Equifax, Trans Union, Experian) to determine the amount by which a credit score on a credit report actually increases when the corrective action is taken. The credit score increase amount selected in step 11 is conservative and represents the lowest value observed in monitoring the amount by which the selected one(s) of the Big Three credit bureaus increases a credit score in response to a particular corrective action. For example, if only Equifax and Trans Union are selected for monitoring to determine the credit score increase in step 11, and if Equivax increases a credit score by at least 12 for a consumer obtaining a new credit card and Trans Union increases a credit score by at least 10 for a consumer obtaining a new credit card, then 10 is selected as the credit score increase in step 11. When the period of time during which a credit bureau is monitored is increased, there is a concomitant increase in the certainty and reliability of the increase in credit score. And when the number of different Big Three and/or Timerge companies monitored increases, there is a concomitant increase in the certainty and reliability of the increase in credit score.

In addition to, or instead of, monitoring one or more of the Big Three credit bureaus, at least one of the Trimerge companies can also be monitored to determine the amount by which the Trimerge company increases a credit report score when the corrective action is taken. In this case, the credit score increase amount selected in step 11 is the lowest value observed in monitoring the amount by which each of the Big Three credit bureaus and/or the selected Trimerge company(s) increases a credit score in response to a particular corrective action.

In step 12, data is obtained that, for each potential corrective action, indicates how recent the last activity must be for a corrective action to have the potential of increasing a customer's credit score. For example, for credit card accounts, any account in which the last activity occurred four (4) or more years ago normally is not considered because a corrective action involving the account will not increase a customer's credit score. The last activity for a credit card account is the date on which the last payment was made on the account, or, is the date on which the account was sent to collections, provided that the account is sent to collections within six (6) months of the last payment.

In step 13, data is obtained that outlines the requirements for a consumer to qualify for “A-paper”. When a consumer has “A-paper”, the consumer ordinarily can qualify for low interest loans. Some mortgage officers and other financial personnel are not certain what the requirements are for a consumer to qualify for “A-paper”.

In step 14, the data assembled in steps 10 to 13 is incorporated for a mortgage officer or other financial personnel in a computer program. This program is described in more detail with respect to FIG. 4.

In step 15, a mortgage officer begins processing a loan.

In step 16, a credit report source is selected by the mortgage officer that is acceptable to the mortgage company that is offering a loan to the consumer.

In step 17, a credit report on the consumer is obtained for the mortgage officer from the selected credit report source.

Step 18 continues the block flow diagram of FIG. 1 to FIG. 2.

Step 19 in FIG. 2 notes that the block flow diagram is continued from FIG. 1.

In step 20 the mortgage officer determines the credit score necessary for the mortgage company to approve the consumer's loan. Step 21 determines if the consumer's credit score reflected in the credit report of step 17 is less than the credit score required in step 20.

If the consumer's credit score is not 23 less, then the mortgage officer finishes processing the consumer's loan. With the exception of the credit scoring adjustment process addressed herein, procedures for processing a mortgage loan are well known and are not detailed herein.

If the consumer's credit score is less 22 than the required credit score, then in step 24 a determination is made of the numerical quantity required for the consumer to reach the required credit score. If, for example, the required credit score in step 20 is 620, and the score reflected on the consumer's credit report in step 17 is 595, then the numerical quantity (or “points”) required for the consumer to reach the required credit score is 620−595=25.

In step 26, the mortgage officer reviews the consumer's credit report to identify possible corrective actions that may be taken to improve the consumer's credit score. The mortgage officer can, at least in part, make this review independently of the consumer in connection with certain possible corrective actions. For example, if a consumer's credit card account is over the limit and the date of last activity is within the last year (i.e., is less than four (4) years), then paying the credit card down under the limit will result in an improvement in the customer's credit score. Or, if the consumer owes more than 50% of the total credit line afforded by adding together the credit lines of all of the consumer's credit cards and these credit card accounts each have a date of last activity within the last four (4) years, then submitting a payment that will bring the total owed to less than 50% will result in an increase in the consumer's credit scores. The mortgage officer can also make the review based on the credit report and supplemental information provided by the consumer. For example, the consumer can confirm if each account listed on the credit report belongs to the consumer. The consumer can confirm when a bankruptcy was properly filed. The consumer can provide, or obtain, letters from creditors confirming the date of last activity, confirming that an account is not a consumer's, confirming that an account has been paid off, confirming that a payment was not late, confirming the amount outstanding in an account, etc.

In step 27, after the mortgage officer has selected possible corrective actions to increase a consumer's credit score, the last activity date is determined for each of the accounts associated with the possible corrective actions.

In step 28, the mortgage officer utilizes the software of step 14 to insure that the date of last activity is sufficiently recent to insure that the selected corrective action will increase the consumer's credit score. For example, an activity date of less than four (4) years is required for credit cards to insure that the selected corrective action will increase the consumer's credit score. If the activity date is not sufficiently recent to insure that the selected corrective action will increase the consumer's credit score 30, then the proposed corrective action is omitted 32. If the activity date is sufficiently recent to insure that the selected corrective action will increase the consumer's credit score 29, then proceed to step 31, and thence to steps 33 and 34 in FIG. 3

In step 34, the mortgage officer utilizes the computer program of step 14 to determine for the selected corrective action(s) the credit score increase that will be produced.

In step 35, the mortgage officer determines if the credit score increase is sufficient for the consumer's credit score to reach the required credit score of step 20.

If the credit score increase is not sufficient to increase the consumer's credit score at least to the required credit score of step 20, then another corrective action is selected and steps 28 to 35 are repeated until the consumer's credit score is increased the desired amount or until the mortgage officer determines that it likely is not possible to increase the consumer's credit score the required amount.

If the credit score increase is sufficient to increase the consumer's credit score at least to the required credit score of step 20, then the mortgage officer completes 36 the mortgage application process.

FIG. 4 illustrates apparatus utilized in the invention, including a consumer's credit report and score 40, and including credit information 41 provided by the consumer comprising, by way of example and not limitation, the last activity date of an account, accounts listed on the consumers credit report and owned or not owned by the consumer, inaccurate late payment information on the consumer's credit report, etc. Possible corrective actions are, as described above, selected by a mortgage officer and a program in computer 100 is utilized to evaluate whether the corrective actions will increase the consumer's credit score a sufficient amount.

Computer 100 includes control 43 and memory 44. Control 43 includes credit card sub-routine 45, car loan sub-routine 46, mortgage sub-routine 47, medical sub-routine 48, bankruptcy sub-routine 49, correction sub-routine 50, and A-Paper sub-routine 51. Memory 44 includes credit card data 55, car loan data 56, mortgage data 57, medical data 58, bankruptcy data 59, correction data 60, and A-Paper data 61. The data in memory 44 is used by control 43 and the sub-routines therein to produce menus and facilitate the functioning of control 43. Computer 100 is utilized by a mortgage loan officer or other financial officer to determine an increase in credit score 53 that a corrective action will produce. The mortgage officer determines if the increase in credit score 53 is sufficient to reach the credit score necessary to secure the loan 62 required by a consumer to buy a home, refinance a home loan, buy a business, refinance a business, obtain a line of credit, etc.

Menus 1 to 6 are set forth on the pages following the below example and are referred to in the example.

### EXAMPLE

A consumer applies for a mortgage to buy a residence. The residences costs $425,000.00. The consumer supplies a $50,000.00 down payment and applies for a loan to cover the $375,000.00 balance. The mortgage officer determines that the mortgage company that will supply the loan requires a credit score of 620 on an Equifax credit report on the consumer. The mortgage officer obtains a copy of the consumer's current Equifax credit report. The credit report shows a credit score of only 575. Consequently, the consumer must raise his credit score by at least 45 points in order to qualify for the loan. On reviewing the customer's credit report, the mortgage officer notes that
1. The last activity on each of the credit card accounts is within the last year.
2. The consumer has eight credit cards. The cards have limits of $500.00, $1000.00, $5000.00, $10,000.00, $6,000.00, $9,000.00, $1,000.00, and $2,500.00, for a total cumulative limit of $35,000.00. The total outstanding amount on the cards is $19,200.00, which is $1,700.00 over 50% of the total cumulative limit.
3. $10,700.00 is owed on the consumer's $10,000.00 credit card. This credit card is therefore $700.00 over the limit.
4. A medical account in the amount of $400.00 has been outstanding for eight (8) months.
5. The consumer indicates that a credit card account listed on the consumer's credit report is not the consumer's.
6. The most recent payment for the consumer's $2,500.00 card is listed on the credit report as late. The consumer indicates that the payment was not late.
   The mortgage officer opens the software of step 14, including the control 43 and memory 44 illustrated in FIG. 4. MENU 1, the home page, appears on the computer monitor. MENU 1 is illustrated below. The mortgage officer first clicks on “Credit card account” The credit card sub-routine 45 of control 43 causes MENU 2 to be displayed on the monitor instead of MENU 1. The mortgage officer notes the question in MENU 2:

### B. Is the date of last activity (4) or more years ago?

The mortgage officer notes that the date of last activity for the credit card accounts is less than four (4) years old and therefore clicks on “Continue to Next Page” at the bottom of the MENU 2. The credit card sub-routine 45 causes MENU 2A to appear on the computer monitor. The mortgage officer notes that the combined balance due on all of the credit cards is in excess of 50% of the total credit limit and therefore clicks the following in the upper portion of MENU 2A:

### “The combined balance due on all of the credit cards is in excess of 50% of the total credit limit.”

The sub-routine 45 causes MENU 2B to appear on the computer monitor. The mortgage office notes that MENU 2B states that paying down to consumer's credit cards so the combined credit limit is less than 50% will increase the consumer's credit score by 15 points. The mortgage officer clicks on “Prior Page” at the bottom of the MENU 2B. The sub-routine 45 causes MENU 2B to reappear on the computer monitor.

The mortgage officer notes that one of the consumer's credit cards is over limit and therefore clicks on:

### “The balance due on any card is over the limit of the card.”

The sub-routine 45 causes MENU 2C to appear on the computer monitor. The mortgage officer notes that if the consumer gets under limit the credit card account that is over limit, then the consumer's credit score will increase by 10 points.

The mortgage officer clicks on “Prior Page” at the bottom of the MENU 2C. The sub-routine 45 causes MENU 2A to reappear on the computer screen.

The mortgage officer notes there is an account on the consumer's credit report that does not belong to consumer. The mortgage officer clicks on:

### “An account is on the credit report that does not belong to the customer.”

The sub-routine 45 causes MENU 2D to appear on the monitor. The mortgage officer notes that if the incorrectly listed credit card account is deleted from the consumer's credit report, then the consumer's credit score will increase by 10 points. The mortgage officer clicks with the computer mouse on “Prior Page” at the bottom of MENU 2D. The sub-routine 45 causes MENU 2A to reappear on the computer monitor.

The mortgage officer notes that one of the consumer's recent credit card payments is shown as late on the consumer's credit report when in reality the payment was not late and all other payments shown on the credit report were timely. The mortgage officer clicks on:

### “An account is on the credit report that incorrectly states the customer is late in making a payment, and the customer has never been late.”

The sub-routine 45 causes MENU 2E to appear on the monitor screen. The mortgage officer notes that if the consumer's credit report is corrected to show that the late payment was actually timely made, then the consumer's credit score will increase by ten points. The mortgage officer clicks on “Back to Home Page” at the bottom of MENU 2E. The sub-routine 45 causes MENU 1 to reappear on the monitor screen. At this point, the mortgage officer has established that the consumer's credit score can be increased as follows:

| | Credit Score |
|---|---|
| Action | Increase |
| Paying credit cards below cumulative | 15 |
| 50% of total credit limit. | |
| Paying over limit card down so balance | 10 |
| owed is less than card limit. | |
| Correcting credit report to delete credit | 10 |
| card account that does not belong to | |
| consumer. | |
| Correcting credit report to show that | 10 |
| credit card account payment was not late. | |
| TOTAL INCREASE IN CREDIT SCORE | 45 |

Since the consumer could pay off the outstanding medical bill noted above and increase the consumer's credit score, the mortgage officer could have clicked on “Medical (Dr./Hospital)” in MENU 1 to cause medical sub-routine 47 to display MENU 3; clicked on “Continue to next page.” to cause sub-routine 47 to display MENU 3A; and, clicked on “The account is less than one year old.” to cause sub-routine 47 to display MENU 3B that indicates if the consumer pays off the medical bill his credit score increases ten (10) points. The mortgage officer, however, already had identified the actions necessary to obtain at least the forty-five (45) points necessary to secure the loan. Consequently, the mortgage officer did not have to proceed further.

The mortgage officer recommends, and the consumer agrees, that consumer:
1. Pay $1,700.00 on the customer's $10,000.00 credit card to get the card below its limit and to get the total amount owed on all credit card accounts below 50% of the total cumulative credit limit of all of customer's credit cards.
2. Obtain letter from appropriate creditor that payment on the pertinent credit card account was not late.
3. Obtain letter from appropriate creditor confirming that the pertinent account on the customer's credit report does not belong to consumer.
   After customer takes the foregoing actions, the mortgage officer returns to MENU 1 and clicks on “Correcting credit report.” The correction sub-routine 50 causes MENU 6 to appear on the screen. The mortgage officer clicks on “Account that does not belong to customer.” The correction sub-routine 50 causes MENU 6A to appear on the screen. The mortgage officer completes the letter provided in MENU 6A by inserting the date, name and address of Equifax, and the mortgage officer's title. The mortgage officer places an “x” in each of the boxes and clicks on “Print letter” to cause sub-routine 50 to transmit the letter to a printer (not shown) to be printed. The mortgage officer signs the letter, places the letter in an envelope with a copy of the consumer's credit report and with a copy of the letter that the consumer obtained from the creditor establishing that the pertinent account does not belong to the consumer. The mortgage officer mails the envelope. The mortgage office has the option of also completing the letter in MENU 6A to be mailed to Trans Union and Experian. The mortgage officer clicks on “Prior Page” The sub-routine 50 causes MENU 6 to reappear on the monitor.

The mortgage officer clicks on “A late payment.” The sub-routine 50 causes MENU 6B to appear on the screen. The mortgage officer completes the letter provided in MENU 6B by inserting the date, name and address of Equifax, and the mortgage officer's title. The mortgage officer places an “x” in each of the boxes and clicks on “Print letter” to cause sub-routine 50 to transmit the letter to a printer for printing. The mortgage officer signs the letter, places the letter in an envelope with a copy of the consumer's credit report and with a copy of the letter that the consumer obtained from the creditor establishing that the pertinent payment was not late. The mortgage officer mails the envelope. The mortgage office has the option of also completing the letter in MENU 6B to be mailed to Trans Union and Experian. The mortgage officer clicks on “Prior Page”. The sub-routine 50 causes MENU 6 to reappear on the monitor.

The mortgage officer clicks on “A credit card over limit.” The sub-routine 50 causes MENU 6C to appear on the screen. The mortgage officer completes the letter provided in MENU 6C by inserting the date, name and address of Equifax, and the mortgage officer's title. The mortgage officer places an “x” in each of the boxes and clicks on “Print letter” to cause sub-routine 50 to transmit the letter to a printer for printing. The mortgage officer signs the letter, places the letter in an envelope with a copy of the consumer's credit report and with a copy of the letter that the consumer obtained from the creditor establishing that the pertinent account does not belong to the consumer. The mortgage officer mails the envelope. The mortgage office has the option of also completing the letter to be mailed to Trans Union and then completing the letter again to be mailed to Experian. The mortgage officer clicks on “Back to Home Page” The sub-routine 50 causes MENU 1 to reappear on the monitor.

Alternatively, in addition to mailing to Equifax the letters derived from MENUS 6A-6C, the mortgage officer can provide copies of the letters and attachments to a Trimerge company to obtain a rescore. The Trimerge company submits documentation comprising the letters and attached documents to one or all of the Big Three credit bureaus. The credit bureaus confirm the facts represented in the documentation, typically within three to five days. Once the information is confirmed, the Trimerge Company utilizes its own computer program and/or procedure to rescore the consumer's credit report and then reports the rescore to the mortgage officer.

As will be recognized by those of skill in the art, auxiliary menus are provided below in connection with the headings or selections “Credit card account”, “Medical (Dr./Hospital)”; “Bankruptcy”. “Correcting credit report” and “A-paper requirements” in MENU 1. The “Car/truck loan account” and “Home mortgage account” selections are not provided herein with auxiliary menus. Such menus can be provided in software provided a mortgage office and would enable the mortgage officer to readily access—in the manner of the other auxiliary menus provided herein—common corrective actions that can be taken in connection with such accounts to improve a consumer's credit score.

If the mortgage officer clicks on “Bankruptcy” in MENU 1, the bankruptcy sub-routine 49 causes MENU 4 to appear on the computer monitor. If the mortgage officer clicks on “Continue to Next Page” in MENU 4, sub-routine 49 causes MENU 4A to appear on the computer monitor.

It is advantageous for the mortgage officer to be aware of the requirements necessary for a consumer to qualify for “A-paper” and, consequently, for low interest loans. If the mortgage office clicks on “A-paper requirements” in MENU 1, the “A-paper sub-routine” 51 causes MENU 5 to appear on the computer monitor.

The method and apparatus of the invention are specifically intended for use by mortgage loans officers to determine and obtain credit score improvements necessary to secure mortgage and other financial loans or lines of credit for customers. A method and apparatus apparently previously did not exist that enables mortgage officers to determine accurately with a high degree of confidence how much a particular corrective action will increase the credit score of a consumer. The method and apparatus of the invention can also be adapted and utilized to enable mortgage officers to evaluate how a corporation, limited liability company, or other business entity can increase its credit score to obtain loans or lines of credit.

The invention is not intended to function to be consumer friendly, is not intended to function to educate consumers about credit reports, is not intended to function to be used by consumers to explain how to improve credit scores, is not intended to function to explain to consumers how credit bureaus and Trimerge companies operate, and is not intended to function to educate consumers about the mortgage process.

[image]

[image]

[image]

[image]

[image]

[image]

[image]

[image]

[image]

[image]

[image]

[image]

[image]

[image]

[image]

[image]

[image]

[image]

[image]

[image]

[image]

[image]

Having described the presently preferred embodiments and best mode of the invention in such terms as to enable those of skill in the art to understand and practice the invention, I Claim:

1. A method for use in processing a mortgage loan for a customer having financial records and having a credit report score less than the score necessary to obtain the mortgage loan, comprising the steps of
(a) providing a computer program that provides for each of a plurality of different corrective financial actions with a high degree of certainty a specific conservative amount by which the corrective financial action increases a customer's credit report score as calculated by a selected credit bureau;
(b) determining a required credit score necessary to secure the loan from a selected mortgage company;
(c) determining the customer's actual credit score;
(d) determining the amount by which the customer's actual credit score must be increased to reach the required credit score of the selected mortgage company;
(e) reviewing a credit report on the customer to select at least one possible selected corrective action to increase the customer's credit score;
(f) utilizing said computer program to determine for said selected corrective action said specific conservative amount by which said selected corrective financial action increases the customer's credit report score; and,
(g) determining if said specific conservative amount for said selected corrective action is at least equal to said amount by which the customer's actual credit score must be increased; and,
(h) if said specific conservative amount for said selected corrective action is at least equal to said amount by which the customer's actual credit score must be increased, continuing processing the loan.

2. Apparatus for facilitating by a mortgage officer the processing of a mortgage loan for a customer having financial records and having a credit report score less than the score necessary to obtain the mortgage loan, comprising
(a) a computer for the mortgage officer;
(b) a computer program on said computer that provides for each of a plurality of different corrective financial actions
(i) with a high degree of certainty a specific conservative amount by which the corrective financial action increases a customer's credit report score as calculated by a selected credit bureau, and
(ii) a plurality of correction formats for the mortgage officer to correspond with a credit bureau to alter customer data maintained by the credit bureau;
(c) a credit report on the customer to enable selection by the mortgage officer of at least one possible selected corrective action to increase the customer's credit score; and,
(d) a printer for the mortgage officer to print said correction formats.
